(19) United States
(12) Patent Application Publication
(10) Pub. No.: US 2004/0086224 A1
(43) Pub. Date: May 6, 2004

(54) Optical network with distributed signal regeneration

(76) Inventors: Jorg-Peter Elbers, Munchen (DE); Christoph Glingener, Feldkirchen-Westerham (DE)

Correspondence Address: BELL, BOYD & LLOYD, LLC, P. O. BOX 1135, CHICAGO, IL, 60690-1135, US

(21) Appl. No.: 10/472,746

(22) PCT Filed: Feb. 25, 2002
(86) PCT No.: PCT/DE02/00682

(30) Foreign Application Priority Data
Mar. 20, 2001 (DE) 101 13 563.7

(51) Int. Cl. G02B 6/26; G02B 6/42

(52) U.S. Cl. 385/31

(57) ABSTRACT

A method and device are provided for the regeneration of optical signals, including one or more devices that are capable of regenerating various optical signals received by the device. The device includes a system for determining the quality of the received optical signal and the signal regeneration devices regenerate only those signals for which the quality detection system has detected a poor signal quality.

The invention relates to an apparatus for regenerating optical signals in accordance with the preamble of claim 1, an optical message-transmission network including at least one first and one second such apparatus, and a method for regenerating optical signals in accordance with the preamble of claim 13.

In optical messaging networks, WDM binary signals (WDM=wavelength division multiplex) which are fed into an optical fiber by a sender are carried via one or more network nodes to a recipient. As part this activity, interference caused by noise, crosstalk, delay difference, etc. accumulates. This is particularly evident in large optical networks with many network nodes and long optical-fiber sections.

Optical regenerators, e.g. so-called 3R regenerators, are used to compensate for the interference effects. In a 3R regenerator (Reamplifying, Retiming, Reshaping), a received optical binary signal is amplified, retimed, reshaped and then forwarded. To this end, the received optical signal is first supplied to an opto-electrical converter, for example. The electrical signal supplied by the converter is amplified and filtered, and then forwarded to a sampling device. Said sampling device decides whether a logical “one” or a logical “zero” was received, and supplies a corresponding signal to a signal shaper. Said signal shaper controls an electro-optical converter, at instants which are determined by a timing regenerator, thereby ensuring that an optical signal which is output by the converter is timed correctly.

An example of a 3R regenerator is described in “telecom report”, 10th year, March 1987, Spezial, Multiplex- und Leitungseinrichtungen, pages 109 to 114.

The manufacturing costs of 3R regenerators are relatively high, due to the required opto-electrical and electro-optical conversion. This is particularly disadvantageous when network nodes having large numbers of ports are used (a large number of connected optical fibers and a large number of multiplexed wavelengths), because the number of 3R regenerators corresponds to the number of ports. In addition to this, 3R regenerators require a relatively large amount of space.

The problem addressed by the invention is to provide a new type of apparatus for regenerating optical signals, a new type of optical message-transmission network, and a new type of method for regenerating optical signals.

The invention solves this problem and other problems by providing an apparatus for regenerating optical signals, said apparatus having one or more devices which can regenerate a plurality of different optical signals that are received by the apparatus, wherein the apparatus has a device for determining the quality of the received optical signals, and wherein the signal regeneration devices only regenerate those signals for which a poor signal quality was determined by the quality determining device.

Furthermore, the invention solves the aforementioned problem and other problems by means of a method in accordance with claim 13 and by means of an optical message-transmission network in accordance with claim 15.

Advantageous developments of the invention are specified in the dependent claims.

Each signal regeneration device is preferably configured such that it can regenerate, at a specified time, a specified number of the optical signals received by the apparatus (e.g. one optical signal in each case). In accordance with an advantageous embodiment of the invention, the number of signal regeneration devices is smaller than the number of signals received by the apparatus. This is possible because, according to the statistical average, only some of the received signals are of such poor quality that regeneration is required.

The reduced number of signal regeneration devices leads to a reduction in manufacturing costs and in the dimensions of the regeneration apparatus.

The invention is explained below in greater detail, with reference to a plurality of exemplary embodiments and drawings in which:

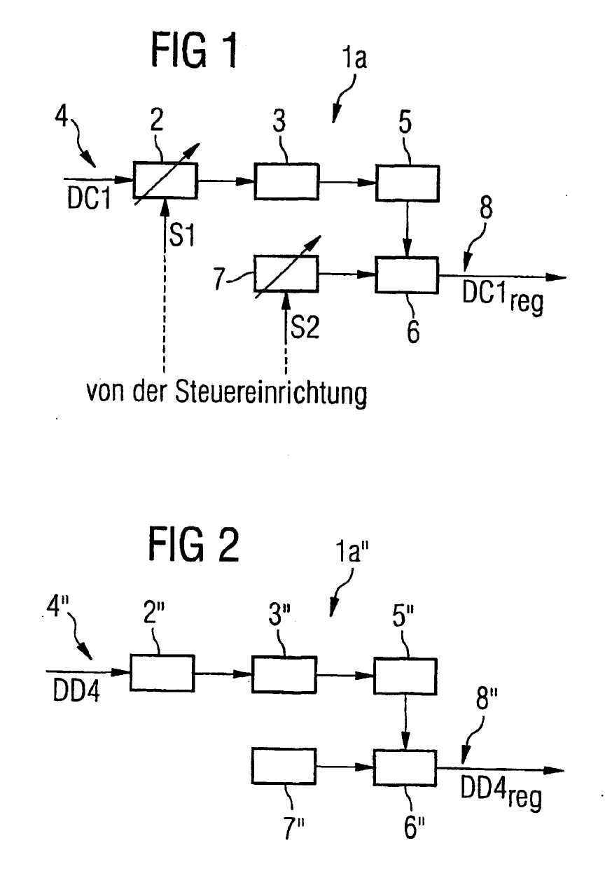

FIG. 1 shows a block diagram of a 3R regenerator which works with variable wavelengths,

FIG. 2 shows a block diagram of a 3R regenerator which works with a fixed wavelength,

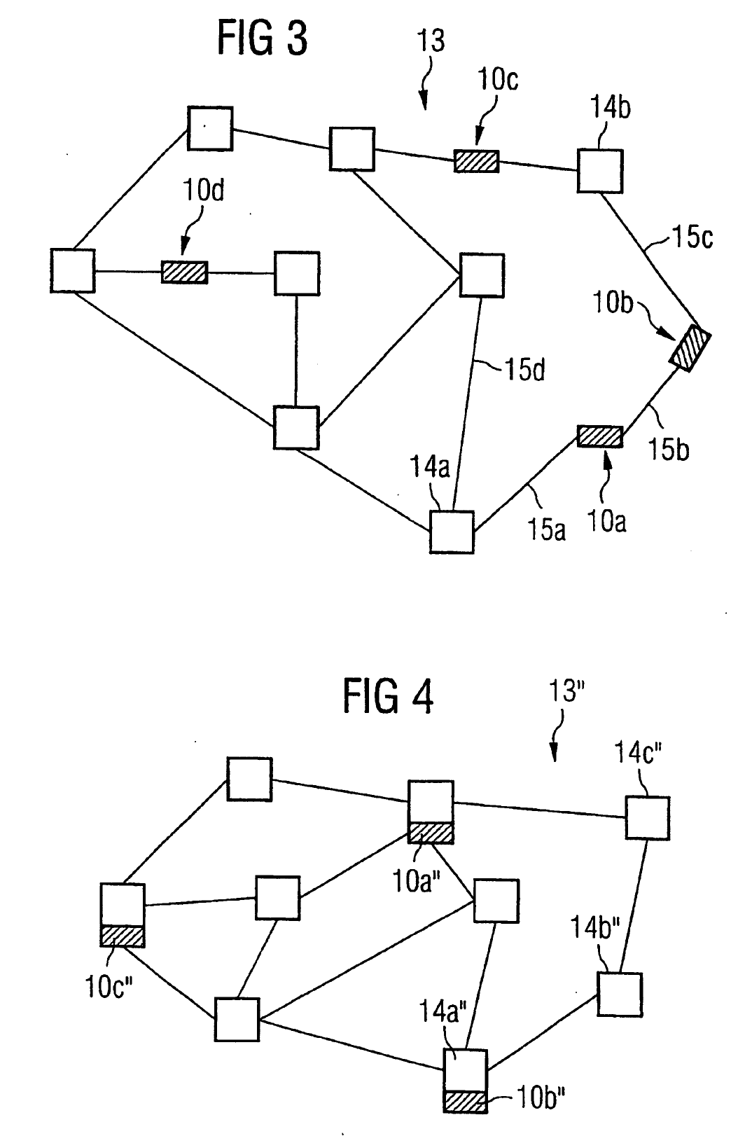

FIG. 3 shows a schematic diagram of an optical message network in accordance with a first exemplary embodiment of the present invention,

FIG. 4 shows a schematic diagram of an optical message network in accordance with a further exemplary embodiment of the present invention,

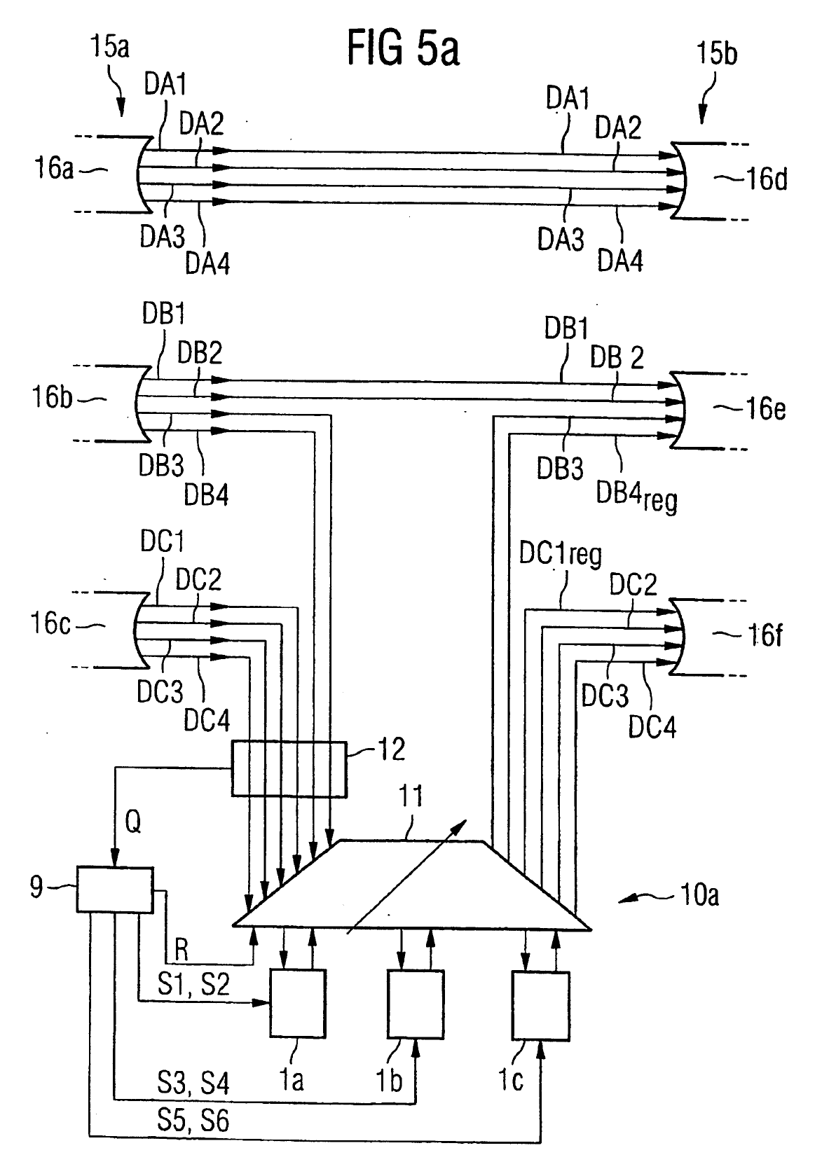

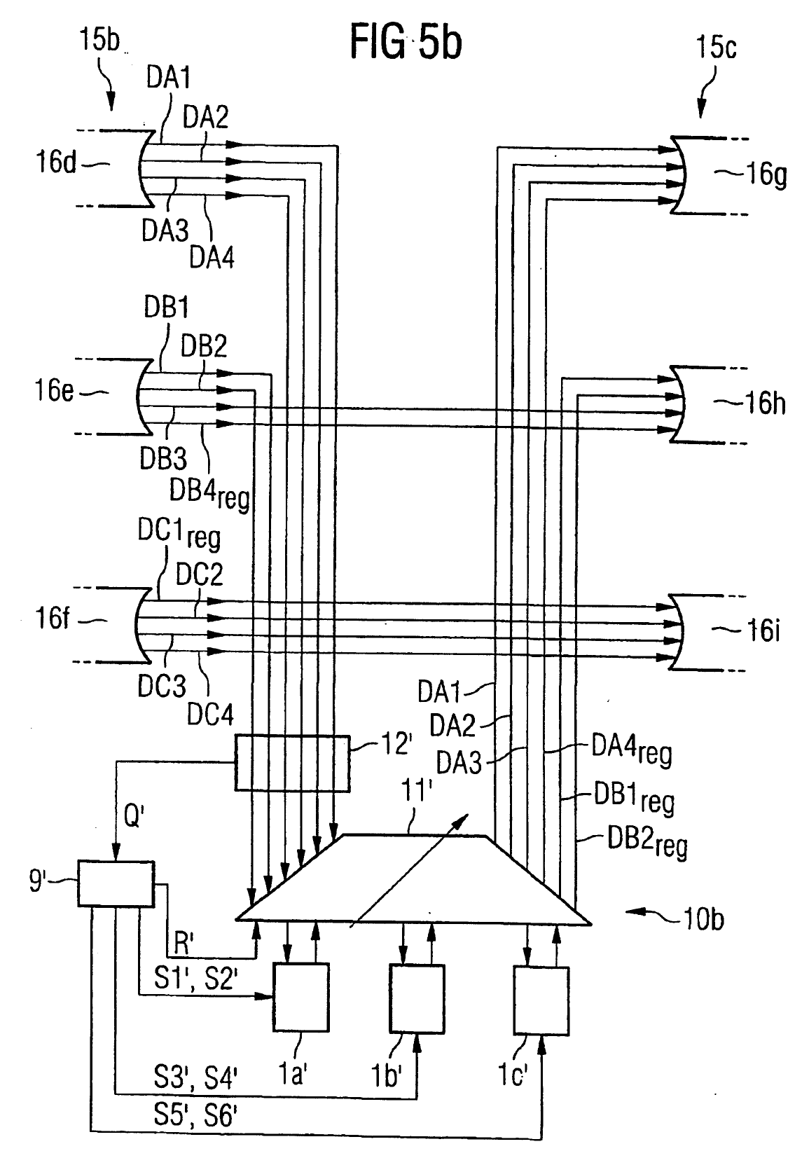

FIG. 5a shows a schematic diagram of an apparatus for regenerating optical signals, said apparatus being used in the message network in accordance with FIG. 3,

FIG. 5b shows a schematic diagram of a further apparatus for regenerating optical signals, said apparatus being used in the message network in accordance with FIG. 3,

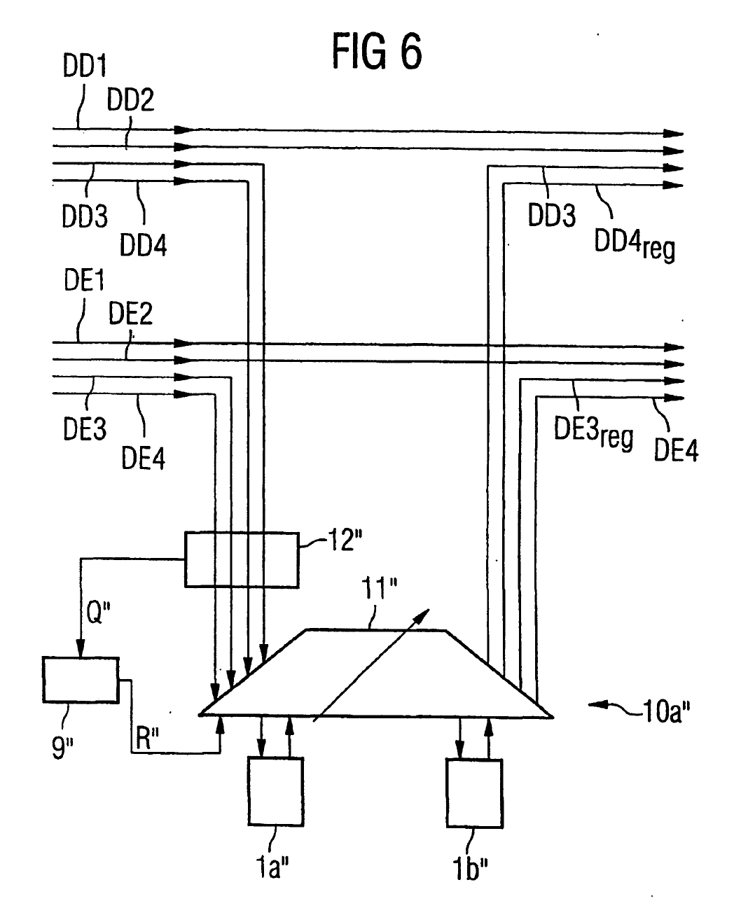

FIG. 6 shows a schematic diagram of an apparatus for regenerating optical signals, said apparatus being used in the message network in accordance with FIG. 4.

In accordance with FIG. 1, a first 3R regenerator 1a, which works with variable wavelengths and is used in a first exemplary embodiment of the present invention, has an optical input 4, an optical filter 2, an electro-optical converter 3, a signal processing device 5, a modulator 6, a laser diode 7, and an optical output 8.

A pulsed optical signal DC1, which is carried via an optical fiber, is supplied to the input 4 of the 3R regenerator 1a and then input into the optical filter 2. Said optical filter allows only those signal parts having a wavelength within a specified wavelength range to pass. The permitted wavelength range of the optical filter 2 can be set variably by means of a first control signal S1 which is supplied by a control device 9 as shown in FIG. 5a.

Again with reference to FIG. 1, the signal which is output by the optical filter 2 is supplied to the opto-electrical converter 3, which converter converts it into an electrical signal which is input into the signal processing device 5. In the signal-processing device 5, the electrical signal is initially amplified, and then sampled in order to determine whether a logical “one” or a logical “zero” was received. The signal-processing device 5 consequently outputs a control signal to the modulator 6 at times which are specified by a timing regenerator (not shown). According to the control signal, said modulator allows a laser beam which is produced by the laser diode 7 to pass, such that a pulsed optical output signal DC1_{reg} is transmitted at the output 8, said output signal being amplified, retimed and reshaped in comparison with the optical input signal DC1.

The laser beam produced by the laser diode 7 has a wavelength which can be set variably by a second control signal S2, said second control signal being supplied by the control device 9.

As shown in FIG 5a, a first signal regeneration apparatus 10a, which is used in the first exemplary embodiment of the invention, has a second 3R regenerator 1b and a third 3R regenerator 1c in addition to the first 3R regenerator 1a shown in FIG. 1. The second and third 3R regenerators 1b, 1c are identical in structure to the first 3R regenerator 1a described above.

Furthermore, the first signal regeneration apparatus 10a includes a signal supply device 11, the aforementioned control device 9, and a signal quality determining device 12.

The first signal regeneration apparatus 10a is part of an optical message network 13 illustrated in FIG. 3. In addition to the first signal regeneration apparatus 10a, said network has a second signal regeneration apparatus 10b, a third signal regeneration apparatus 10c, a fourth signal regeneration apparatus 10d, further signal regeneration apparatuses which are not shown here, and a multiplicity of network nodes 14a, 14b. The individual network nodes 14a, 14b are interconnected via optical fiber line groups 15a, 15b, 15c, 15d, with intermediate connections being formed by the signal regeneration apparatuses 10a, 10b, 10c, 10d.

For example, a first optical fiber line group 15a runs from a first network node 14a to the first signal regeneration apparatus 10a, from which a second optical fiber line group 15b runs to the second signal regeneration apparatus 10b. The latter is connected to a second network node 14b via a third optical fiber line group 15c.

Again with reference to FIG. 5a, each optical fiber line group 15a, 15b, 15c, 15d has a plurality (three in this case) of optical fibers 16a, 16b, 16c, 16d, 16e, 16f. Using wavelength division multiplexing, each optical fiber 16a, 16b, 16c, 16d, 16e, 16f carries a plurality (four in this case) of different pulsed optical signals in each case. In the exemplary embodiment illustrated here, a first optical fiber 16a carries four multiplexed signals DA1, DA2, DA3, DA4, a second optical fiber 16b carries four further multiplexed signals DB1, DB2, DB3, DB4, and a third optical fiber 16c carries four multiplexed signals DC1, DC2, DC3, DC4.

The four signals DA1, DA2, DA3, DA4 of the first optical fiber 16a and the first and second signals DB1, DB2 of the second optical fiber 16b (i.e. a first subset of the aforementioned signals DA1, DA2, DA3, DA4, DB1, DB2, DB3, DB4, DC1, DC2, DC3, DC4) are forwarded directly to a fourth and fifth optical fiber 16d, 16e—without any regeneration being carried out by the signal regeneration apparatus 10a—and onwards from there toward the second signal regeneration apparatus 10b and the second network node 14b.

In contrast, the second and third signals DB3, DB4 of the second optical fiber 16b and the four signals DC1, DC2, DC3, DC4 of the third optical fiber 16c (i.e. a second subset of the aforementioned signals DA1, DA2, DA3, DA4, DB1, DB2, DB3, DB4, DC1, DC2, DC3, DC4) are supplied to the signal quality determining device 12.

This contains a conventional Q-Monitor (not shown) which determines the respective quality of the individual signals DB3, DB4, DC1, DC2, DC3, DC4. Depending on the determined signal quality, the signal quality determining device 12 selects up to three signals (the two signals DB4, DC1 in this case) which are to be regenerated by the signal regeneration apparatus 10a. For example, the selection could comprise the three signals having the poorest quality in each case, or all signals having a quality which is lower than a predefined reference value. The signal quality determining device 12 then sends a signal selection signal Q to the control device 9, to tell said device which signals DB4, DC1 are to be regenerated.

All the signals DB3, DB4, DC1, DC2, DC3, DC4 received by the signal quality determining device 12 are forwarded to the signal supply device 11. A signal R from the control device 9 tells the signal supply device 11 which signal is to be regenerated by the first 3R regenerator 1a (the signal DC1 in this case), which signal is to be regenerated by the second 3R regenerator 1b (the signal DB4 in this case), and which signal is to be regenerated by the third 3R regenerator 1c (no signal in this case). The signal supply device 11 forwards the signals to be regenerated DC1, DB4 to the corresponding 3R regenerators 1a, 1b. By contrast—and without regeneration—the signal DB3 is routed directly to the optical fiber 16e and the signals DC2, DC3, DC4 are routed directly to the optical fiber 16f, whence they are forwarded toward the second signal regeneration apparatus 10b and the second network node 14b.

With reference to the first control signal S1 explained above in relation to FIG. 1, the control device 9 sends the first 3R regenerator 1a the wavelength of the signal DC1 which it is to regenerate. The second control signal S2 is used to specify the required wavelength of the regenerated signal DC1_{reg} output by the first 3R regenerator 1a. This wavelength can be same as the wavelength of the signal to be regenerated DC1, but can also be different as an alternative.

Like the first and second control signals S1, S2, corresponding control signals S3, S4, and S5, S6 are also sent by the control device 9 to the second and third 3R regenerators 1b, 1c respectively. In this way, it is possible to specify the wavelength of the signal DB4 which is to be regenerated by the relevant 3R regenerator 1b, 1c, and the wavelength of the signal DB4_{reg} which is regenerated by the relevant 3R regenerator 1b, 1c.

In accordance with the procedure explained above with reference to FIG. 1, the signal DC1, DB4 which is input into the respective 3R regenerator 1a, 1c, 1c is regenerated, and the regenerated output signal DC1_{reg}, DB4_{reg} which is produced by the respective 3R regenerator 1a, 1b, 1c is input into the signal supply device 11. This device forwards the regenerated signal DB4_{reg} to the optical fiber 16e, and the regenerated signal DC1_{reg} to the optical fiber 16f.

All signals DA1, DA2, DA3, DA4, DB1, DB2, DB3, DB4_{reg}, DC1_{reg}, DC2, DC3, DC4 are then forwarded via the corresponding optical fiber 16d, 16e, 16f to the second signal regeneration apparatus 10b. In accordance with FIG. 5b, this apparatus has a similar structure to the first signal regeneration apparatus 10b, and has a fourth 3R regenerator 1a′, a fifth 3R regenerator 1b′, a sixth 3R regenerator 1c′, a signal supply device 11′, a control device 9′, and a signal quality determining device 12′. The fourth, fifth and sixth 3R regenerators 1a′, 1b′, 1c′ are identical in structure to the first 3R regenerator 1a described above in relation to FIG. 1.

In accordance with FIG. 5b, the four signals DC1_{reg}, DC2, DC3, DC4 of the sixth optical fiber 16f and the third and fourth signals DB3, DB4_{reg} of the fifth optical fiber 16e are forwarded directly to a seventh and eighth optical fiber 16g, 16h of the third optical fiber line group—without any regeneration being carried out by the signal regeneration apparatus 10b—and onwards from there toward the second network node 14b.

In contrast, the first and second signals DB1, DB2 of the fifth optical fiber 16e and the four signals DA1, DA2, DA3, DA4 of the fourth optical fiber 16d are supplied to the signal quality determining device 12′.

This has a structure which corresponds to the signal quality determining device 12 described in relation to FIG. 5a. It has a conventional Q-Monitor (not shown) which determines the quality of the signals DA1, DA4, DA3, DA4, DB1, DB2. Depending on the determined signal quality, the signal quality determining device 12′ selects up to three signals (the three signals DA4, DB1, DB2 in this case) which are to regenerated by the signal regeneration apparatus 10b. The signal quality determining device 12′ then sends a signal selection signal Q′ to the control device 9′, to tell said device which signals DA4, DB1, DB2 are to be regenerated.

All the signals DA1, DA4, DA3, DA4, DB1, DB2 received by the signal quality determining device 12′ are forwarded to the signal supply device 11′. A signal R′ from the control device 9 tells the signal supply device 11′ which signal is to be regenerated by the fourth 3R regenerator 1a′ (the signal DA4 in this case), which signal is to be regenerated by the fifth 3R regenerator 1b′ (the signal DB1 in this case), and which signal is to be regenerated by the sixth 3R regenerator 1c (the signal DB2 in this case). The signal supply device 11′ forwards the signals to be regenerated DA4, DB1, DB2 to the corresponding 3R regenerators 1a′, 1b′, 1c′. By contrast—and without regeneration—the signals DA1, DA2, DA3 are routed directly to the optical fiber 16g, whence they are forwarded toward the second network node 14b.

The control device 9′ has a structure which corresponds to the control device 9 described in relation to FIGS. 1 and 5a. It supplies a pair of control signals S1′, S2′ and S3′, S4′ and S5′, S6′ in each case to the fourth, fifth and sixth 3R regenerators respectively, in order to indicate what wavelength the signal DA4, DB1, DB2 which is to be regenerated by the respective 3R regenerator 1a′, 1b′, 1c′, and the signal DA4_{reg}, DB1_{reg}, DB2_{reg} which is regenerated by the respective 3R regenerator 1a′, 1b′, 1c should have.

As explained above in relation to FIG. 1, the signal DA4, DB1, DB2 which is input into the respective 3R regenerator 1a′, 1b′, 1c′ is regenerated, and the regenerated output signal DA4_{reg}, DB1_{reg}, DB2_{reg} which is produced by the respective 3R regenerator 1a′, 1b′, 1c′ is input into the signal supply device 11. This device forwards the regenerated signal DA4_{reg} to the optical fiber 16g and the regenerated signals DB1_{reg}, DB2_{reg} to the optical fiber 16h, whence the signals DA4_{reg}, DB1_{reg}, DB2_{reg}—like the remaining signals DA1, DA2, DA3, DB3, DB4_{reg}, DC1_{reg}, DC2, DC3, DC4—are forwarded toward the second network node 14b.

In an alternative exemplary embodiment which is not illustrated here, use is made of 3R regenerators which, in contrast to the 3R regenerators 1a, 1b, 1c, 1a′, 1b′, 1c′ illustrated in FIG. 1 or in FIG. 5a, 5b, do not have an optical filter. The function of an integrated optical filter in a 3R regenerator is then assumed by optical filters which are provided in a signal supply device, said device otherwise corresponding to the signal supply devices 11, 11′ explained in relation to FIGS. 5a, 5b.

A further exemplary embodiment of the present invention is described below with reference to the FIGS. 2, 4 and 6.

In accordance with FIG. 2, a 3R regenerator 1a″, which is used in this context and works with a first fixed wavelength λ1, has an optical input 4″, an optical filter 2″, an electro-optical converter 3″, a signal processing device 5|, a modulator 6″, a laser diode 7″, and an optical output 8″.

A pulsed optical signal DD4, which is carried via an optical fiber, is supplied to the input 4″ of the 3R regenerator 1a″ and then input into the optical filter 2″. Said optical filter allows only those signal parts having a wavelength within a specified fixed wavelength range to pass.

The signal which is output by the optical filter 2″ is supplied to the opto-electrical converter 3″, which converter converts it into an electrical signal which is input into the signal processing device 5″. In the signal processing device 5″, the electrical signal is initially amplified, and then sampled in order to determine whether a logical “one” or a logical “zero” was received. The signal processing device 5″ consequently outputs a control signal to the modulator 6″ at times which are specified by a timing regenerator (not shown). According to the control signal, said modulator 6″ allows a fixed-wavelength laser beam which is produced by the laser diode 7″ to pass, such that a pulsed optical output signal DD4_{reg} is transmitted at the output 8″, said output signal DD4_{reg} being amplified, retimed and reshaped in comparison with the optical input signal DD4.

The laser beam produced by the laser diode 7″ has a wavelength which corresponds to the wavelength λ1 of the input signal DD4. In the case of alternative exemplary embodiments which are not shown here, the laser beam produced by the laser diode 7″ can also have a wavelength which differs from the wavelength λ1 of the input signal DD4.

As shown in FIG. 6, a first signal regeneration apparatus 10a″ which is used in the further exemplary embodiment of the invention has, in addition to the 3R regenerator 1a″ shown in FIG. 2, a further 3R regenerator 1b″ which works with a second fixed wavelength λ2. Said further 3R regenerator 1b″ is identical in structure to the 3R regenerator 1a″ described in relation to FIG. 2, except that its optical filter corresponding to the optical filter 2″ allows only those signal parts having the aforementioned second fixed wavelength λ2 to pass, and its laser diode corresponding to the laser diode 7″ produces a laser beam having a wavelength which corresponds to the second fixed wavelength λ2.

Furthermore, in accordance with the signal regeneration apparatuses 10a, 10b shown in the FIGS. 5a and 5b, the first signal regeneration apparatus 10a″ includes a signal supply device 11″, a control device 9″, and a signal quality determining device 12″.

The first signal regeneration apparatus 10a″ is part of an optical message network 13″ illustrated in FIG. 4.

In addition to the first signal regeneration apparatus 10a″ illustrated in FIG. 6, said network has a second signal regeneration apparatus 10b″, a third signal regeneration apparatus 10c″, further signal regeneration apparatuses which are not shown here, and a multiplicity of network nodes 14a″, 14b″, 14c″. The individual network nodes 14a″, 14b″ are interconnected via optical fiber line groups comprising a plurality of optical fibers in each case. In contrast to the first exemplary embodiment of the invention, the signal regeneration apparatuses 10a″, 10b″, 10c″ are arranged directly at the network nodes 14a″ or are part of a network node 14a″ in each case.

Again with reference to FIG. 6, each network node 14a″ receives a plurality (eight in this case) of different, wavelength-division multiplexed, pulsed optical signals DD1, DD2, DD3, DD4, DE1, DE2, DE3, DE4 via the optical fiber line groups which are attached to it. In this case, the signals DD4 and DE4 have the aforementioned first fixed wavelength λ1, the signals DD3 and DE3 have the aforementioned second fixed wavelength λ2, the signals DD2 and DE2 have a third fixed wavelength λ3, and the signals DD1 and DE1 have a fourth fixed wavelength λ4.

The four signals DD1, DD2, DE1, DE2 (i.e. a first subset of the aforementioned signals DD1, DD2, DD3, DD4, DE1, DE2, DE3, DE4) are forwarded directly toward corresponding further network nodes 14a″, 14b″, 14c″—without any regeneration being carried out by the signal regeneration apparatus 10a″.

In contrast, the four signals DD3, DD4, DE3, DE4 (i.e. a second subset of the aforementioned signals DD1, DD2, DD3, DD4, DE1, DE2, DE3, DE4) are supplied to the signal quality determining device 12″.

This contains a conventional Q-Monitor (not shown) which determines the quality of the signals DD3, DD4, DE3, DE4. For each signal wavelength individually, the signal with the poorest quality in each case is selected as the signal which is to be regenerated by the signal regeneration apparatus 10a″ (in this case, the signal DD4 as a signal having the wavelength λ1, and the signal DE3 as a signal having the wavelength λ2).

The signal quality determining device 12″ then sends a signal selection signal Q″ to the control device 9″, to tell said device which signals DD4, DE3 have been selected for regeneration.

All the signals DD3, DD4, DE3, DE4 received by the signal quality determining device 12″ are forwarded to the signal supply device 11″. A signal R″ from the control device 9″ tells the signal supply device 11″ which signal is to be regenerated by the first 3R regenerator 1a″ (the signal DD4 in this case) and which signal is to be regenerated by the further 3R regenerator 1b″ (the signal DE3 in this case). The signal supply device 11 inputs the signals to be regenerated DD4, DE3 into the corresponding 3R regenerators 1a″, 1b″. By contrast—and without regeneration—the signals DD3, DE4 are forwarded directly toward the corresponding further network nodes 14a″, 14b″, 14c″.

In accordance with the procedure explained above with reference to FIG. 2, the signal DD4, DE3 which is input into the respective 3R regenerator 1a″, 1b″ is regenerated, and the regenerated output signal DD4_{reg}, DE3_{reg} which is produced by the respective 3R regenerator 1a″, 1b″ is input into the signal supply device 11″.

This device forwards the regenerated signals DD4_{reg}, DE3_{reg}—together with the remaining signals DD1, DD2, DD3, DE1, DE2, DE4—toward the network nodes 14a″, 14b″, 14c″. These network nodes have signal regeneration apparatuses 10b″, 10c″ which correspond to the aforementioned first signal regeneration apparatus 10a″, but their 3R regenerators work with different fixed wavelengths to the 3R regenerators 1a″, 1b″ of the first signal regeneration apparatus 10a″ (e.g. with the aforementioned third and fourth fixed wavelengths λ3, λ4). Therefore, for example, the signal DD2 or the signal DE2, and the signal DD1 or the signal DE1, can be 3R regenerated as described above in the signal regeneration apparatus 10b″.

Since each signal regeneration apparatus 10a″, 10b″, 10c″ has only a small number of 3R regenerators 1a″, 1b″, the manufacturing costs of the signal regeneration apparatuses 10a″, 10b″, 10c″ are relatively low.

1. An apparatus (10a) for regenerating optical signals, having one or more devices (1a, 1b, 1c) which can regenerate a plurality of different optical signals (DB3, DB4, DC1, DC2, DC3, DC4) received by the apparatus (10a),
characterized in that
the apparatus has a device (12) for determining the quality of the received optical signals (DB3, DB4, DC1, DC2, DC3, DC4), and that the signal regeneration devices (1a, 1b, 1c) regenerate only those signals (DC1, DB4) for which a poor signal quality was determined by the quality determining device (12)

2. The apparatus (10a) as claimed in claim 1, in which the number of signal regeneration devices (1a, 1b, 1c) is smaller than the number of optical signals (DB3, DB4, DC1, DC2, DC3, DC4) received by the apparatus.

3. The apparatus (10a) as claimed in one of the preceding claims, in which the signal regeneration devices (1a, 1b, 1c) are 3R regenerators.

4. The apparatus (10a) as claimed in one of the preceding claims, in which each of the signal regeneration devices (1a, 1b, 1c) amplifies and/or retimes and/or reshapes a signal (DC1, DB4) which is supplied to it.

5. The apparatus (10a) as claimed in one of the preceding claims, in which the received optical signals (DB3, DB4, DC1, DC2, DC3, DC4) have different wavelengths, and each of the signal regeneration devices (1a, 1b, 1c) is configured in such a way that it can regenerate only signals (DB3, DB4, DC1, DC2, DC3, DC4) having predefined, fixed wavelengths.

6. The apparatus (10a) as claimed in one of claims 1 to 4, in which the received optical signals (DB3, DB4, DC1, DC2, DC3, DC4) have different wavelengths, and each of the signal regeneration devices (1a, 1b, 1c) can be set variably to a specified wavelength, such that it can regenerate signals (DB3, DB4, DC1, DC2, DC3, DC4) having different wavelengths.

7. The apparatus (10a) as claimed in claim 6, said apparatus additionally having a control device (9) which tells the respective signal regeneration device (1a, 1b, 1c) the wavelength of the signal (DC1, DB4) which is to be regenerated by the respective signal regeneration device (1a, 1b, 1c).

8. The apparatus (10a) as claimed in one of the preceding claims, in which the signal regeneration devices (1a, 1b, 1c) are configured in such a way that they can be used as wavelength converters.

9. The apparatus (10a) as claimed in one of the preceding claims, in which the signal regeneration devices (1a, 1b, 1c) regenerate only those signals (DC1, DB4) having a quality which is lower than a predefined reference value.

10. The apparatus (10a) as claimed in one of claims 1 to 8, in which the signal regeneration devices (1a, 1b, 1c) regenerate a predefined number of signals (DC1, DB4) which have the poorest signal quality.

11. The apparatus (10a) as claimed in one of the preceding claims, in which the signal regeneration devices (1a, 1b, 1c) can be set to various signal data rates.

12. The apparatus (10a) as claimed in one of claims 1 to 10, in which the signal regeneration devices (1a, 1b, 1c) are configured such that they work at a signal data rate which is predefined and fixed.

13. A method for regenerating optical signals, said method comprising the following steps:
receiving a plurality of different optical signals (DB3, DB4, DC1, DC2, DC3, DC4),
characterized in that
the quality of the received optical signals (DB3, DB4, DC1, DC2, DC3, DC4) is determined, and only those signals (DC1, DB4) having a poor signal quality are regenerated.

14. The method as claimed in claim 13, said method additionally comprising the following steps:
providing a plurality of signal regeneration devices (1a, 1b, 1c), each of which can regenerate one of the received optical signals (DB3, DB4, DC1, DC2, DC3, DC4), wherein the number of signal regeneration devices (1a, 1b, 1c) is smaller than the number of received optical signals (DB3, DB4, DC1, DC2, DC3, DC4).

15. An optical message-transmission network with at least one first and one second apparatus (10a, 10b) for regenerating optical signals in accordance with one of claims 1 to 12, wherein the first apparatus (10a) receives a plurality of different optical signals (DA1, DA2, DA3, DA4, DB1, DB2, DB3, DB4, DC1, DC2, DC3, DC4), processes said signals, and forwards them to the second apparatus (10b), and wherein the signal regeneration devices (1a, 1b, 1c) of the first apparatus (10a) are configured in such a way that they regenerate a first subset of the received signals (DB3, DB4, DC1, DC2, DC3, DC4), and the signal regeneration devices (1a, 1b, 1c) of the second apparatus (10a) are configured in such a way that they regenerate a second subset of the signals (DA1, DA2, DA3, DA4, DB1, DB2), said second subset being different from the first subset.
